(19) United States
(12) Patent Application Publication
(10) Pub. No.: US 2016/0260972 A1
(43) Pub. Date: Sep. 8, 2016

(54) NON-AQUEOUS ELECTROLYTE STORAGE ELEMENT

(71) Applicants: Eiko HIBINO, Kanagawa (JP); Okitoshi KIMURA, Kanagawa (JP); Nobuaki ONAGI, Kanagawa (JP); Satoshi NAKAJIMA, Tokyo (JP); Anna HIROWATARI, Kanagawa (JP); Takashi YAMAGATA, Kanagawa (JP); Tatsumi ISHIHARA, Fukuoka (JP); Yoshihisa TANAKA, Kyoto (JP); Ryo OSHIMA, Kyoto (JP); Toshihiro NAKABO, Kyoto (JP)

(72) Inventors: Eiko HIBINO, Kanagawa (JP); Okitoshi KIMURA, Kanagawa (JP); Nobuaki ONAGI, Kanagawa (JP); Satoshi NAKAJIMA, Tokyo (JP); Anna HIROWATARI, Kanagawa (JP); Takashi YAMAGATA, Kanagawa (JP); Tatsumi ISHIHARA, Fukuoka (JP); Yoshihisa TANAKA, Kyoto (JP); Ryo OSHIMA, Kyoto (JP); Toshihiro NAKABO, Kyoto (JP)

(21) Appl. No.: 15/050,049

(22) Filed: Feb. 22, 2016

(30) Foreign Application Priority Data
Mar. 6, 2015 (JP) 2015-044578
Dec. 4, 2015 (JP) 2015-237641

(51) Int. Cl. H01M 4/587; H01M 10/0569; H01M 4/485; H01M 10/0525

(52) U.S. Cl. CPC H01M 4/587; H01M 10/0525; H01M 10/0569; H01M 4/485; H01M 2004/028

(57) ABSTRACT

To provide a non-aqueous electrolyte storage element including a positive electrode containing a positive electrode active material capable of inserting and eliminating anions, a negative electrode containing a negative electrode active material capable of inserting and eliminating cations, and a non-aqueous electrolyte prepared by dissolving an electrolyte salt in a non-aqueous solvent, wherein the positive electrode active material contains a carbon material, where a distance between (002) planes, d(002), of the carbon material as measured by X-ray diffraction is 0.340 nm or greater but 0.360 nm or less, and the carbon material has a BET specific surface area of greater than 1 m²/g but smaller than 30 m²/g, and the negative electrode active material contains a material capable of inserting and eliminating lithium ions.

### CROSS-REFERENCE TO RELATED APPLICATIONS

The present application claims priority under 35 U.S.C. §119 to Japanese Patent Application No. 2015-044578, filed Mar. 6, 2015 and Japanese Patent Application No. 2015-237641, filed Dec. 4, 2015. The contents of which are incorporated herein by reference in their entirety.

### BACKGROUND OF THE INVENTION

1. Field of the Invention

The present invention relates to non-aqueous electrolyte storage elements.

2. Description of the Related Art

Along with reductions in sizes and improvements in performances of current mobile devices, properties of non-aqueous electrolyte storage elements having high energy densities have been improved, and widely used. Moreover, developments of non-aqueous electrolyte storage elements having the larger capacities and having excellent safety have been carried out, and such the non-aqueous electrolyte storage elements have started to be mount in electric cars.

The aforementioned non-aqueous electrolyte storage element contains a positive electrode, such as lithium-cobalt composite oxide, a negative electrode, which is carbon, and a non-aqueous electrolyte prepared by dissolving lithium salt in a non-aqueous solvent. Often used is lithium ion secondary batteries. In the lithium ion secondary battery, lithium in the positive electrode is eliminated and inserted into the carbon of the negative electrode, at the time of charging. At the time of discharging, the lithium inserted into the negative electrode is eliminated, and returned to the composite oxide of the positive electrode. In the manner as described, the lithium ion secondary battery is charged and discharged.

In the case where a battery element is used as a hybrid car, meanwhile, it is necessary to output a large quantity of electric current instantly. Moreover, the battery element is ideally charged with regenerative energy, and high-current charging-discharging properties are more important than energy density. Accordingly, an electric double layer capacitor, which does not require a chemical reaction, and can perform charging and discharging at high speed, is used. The electric double layer capacitor has the energy density that is one-several tenth the energy density of the lithium ion secondary battery. Therefore, the electric double layer capacitor need to have a large weight in order to secure a sufficient capacity. As a result, use of the electric double layer capacitor in an automobile hinder an improvement of fuel efficiency.

As for a storage element having high energy density and suitable for high-speed charging and discharging, practicalization of a so-called dual intercalation non-aqueous electrolyte storage element has been expected. The dual intercalation non-aqueous electrolyte storage element uses a conductive polymer or carbon material in a positive electrode, carbon in a negative electrode, and a non-aqueous electrolyte prepared by dissolving a lithium salt in a non-aqueous solvent. The dual intercalation non-aqueous electrolyte storage element is charged and discharged by inserting anions in the non-aqueous electrolyte into the cation, and cations in the non-aqueous electrolyte storage element into the negative electrode at the time of charging, and eliminating the anions inserted into the positive electrode, and the cations inserted into the negative electrode to the non-aqueous electrolyte.

In the case where LiPF₆ is used as lithium salt, and carbon is used also in a negative electrode, as depicted by the following reaction formula, charging is performed by inserting PF₆⁻ in a non-aqueous electrolyte into a positive electrode and inserting Li⁺ in the non-aqueous electrolyte into the negative electrode, and discharging is performed by eliminating PF₆⁻, from the positive electrode to the non-aqueous electrolyte, and eliminating Li⁺ from the negative electrode to the non-aqueous electrolyte.

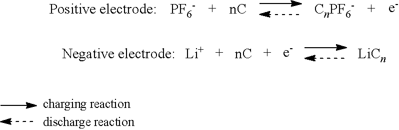

As for an active material to and from which anions are inserted and eliminated, known materials are graphite as disclosed in Japanese Patent Nos. 4569126, 4392169, and 4314087, a carbon material whose specific surface area is increased by alkali activation, as disclosed in Japanese Patent Nos. 5042754 and 5399185, and activated carbon having a large specific surface area as disclosed in Japanese Unexamined Patent Application Publication No. 2012-195563. In case of the graphite, anions are inserted into and eliminated from spaces between layers of the graphite. In case of the carbon material, anions are adsorbed on and eliminated from a surface of the carbon material. In case of the activated carbon, anions are adsorbed to and eliminated from the activated carbon. When graphite to and from which anions can be inserted and eliminated is used, a discharge capacity per a mass of the active material can be made large.

In the case where graphite is used as a positive electrode active material, a secondary battery having a high energy density can be attained by setting the charge termination voltage to the range of from 5.3 V through 5.6 V relative to a lithium reference electrode, as disclosed in Japanese Patent No. 4569126.

Japanese Patent No. 4392169 discloses a secondary battery, which achieves excellent cycling properties through use of boronated graphite. Japanese Patent No. 4314087 discloses, particularly, a structure of a negative electrode in order to attain high-current discharging properties.

Moreover, Japanese Patent Nos. 5042754 and 5399185 disclose, as a positive electrode, use of a carbon material whose specific surface area is made at least lager than 30 m²/g by an alkali activation process (with proviso that the specific surface area thereof is a lot smaller than a specific surface area of activated carbon) instead of graphite. Japanese Unexamined Patent Application Publication No. 2012-195563 discloses use of activated carbon whose specific surface area is large, i.e., about 2,000 m²/g.

In the case where graphite is used as a positive electrode as in the related art, the charging-discharging efficiency cannot stay high and cycling deterioration becomes significant, if charging and discharging are performed at high voltage in order to increase energy density. The charging-discharging efficiency typically stays at high value after several times of charging and discharging. According to the researchers conducted by the present inventors, relatively preferable high-current discharging properties are attained when graphite is used in a positive electrode, but satisfactory high-current charging properties cannot be achieved.

When a carbon material having a large specific surface area is used in a positive electrode, a discharger capacity per unit mass of the active material cannot be made large, and energy density cannot be increased, through a resulting element has excellent high electric current charging properties.

### SUMMARY OF THE INVENTION

The present invention aims to provide a non-aqueous electrolyte storage element, which has a high discharge capacity per unit mass of a positive electrode active material, has excellent high electric current charging properties as well as high electric current discharging properties, and has a high charging-discharging efficiency.

As the means for solving the aforementioned problems, the non-aqueous electrolyte storage element of the present invention includes a positive electrode containing a positive electrode active material capable of inserting and eliminating anions, a negative electrode containing a negative electrode active material capable of inserting and eliminating cations, and a non-aqueous electrolyte prepared by dissolving an electrolyte salt in a non-aqueous solvent. The positive electrode active material contains a carbon material, where a distance between (002) planes, d(002), of the carbon material as measured by X-ray diffraction is 0.340 nm or greater but 0.360 nm or less, and the carbon material has a BET specific surface area of greater than 1 m²/g but smaller than 30 m²/g. The negative electrode active material contains a material capable of inserting and eliminating lithium ions.

The present invention can provide a non-aqueous electrolyte storage element, which has a high discharge capacity per unit mass of a positive electrode active material, has excellent high electric current charging properties as well as high electric current discharging properties, and has a high charging-discharging efficiency.

### BRIEF DESCRIPTION OF THE DRAWINGS

FIG. 1 is a diagram depicting charging-discharging curves of the first, second, and 10th charging-discharging cycles of the non-aqueous electrolyte storage element of Example;

FIG. 2 is a diagram depicting a change in an X-ray diffraction peak of the positive electrode active material of the non-aqueous electrolyte storage element of Example, where the change is caused by charging and discharging; and

FIG. 3 is a diagram depicting a relationship between a true density of the carbon material of the positive electrode and the discharge capacity.

### DETAILED DESCRIPTION OF THE INVENTION

### Structure of Non-Aqueous Electrolyte Storage Element

### 1. Positive Electrode

The positive electrode is appropriately selected depending on the intended purpose without any limitation, provided that the positive electrode contains a positive electrode active material. Examples of the positive electrode include a positive electrode, in which a positive electrode material including a positive electrode active material is disposed on a positive electrode collector.

A shape of the positive electrode is appropriately selected depending on the intended purpose without any limitation. Examples of the shape thereof include a plate shape.

### 1-1. Positive Electrode Material

The positive electrode material is appropriately selected depending on the intended purpose without any limitation. For example, the positive electrode material contains at least a positive electrode active material, and may further contain a conduction promoting agent, a binder, and a thickening agent, if necessary.

### (1) Positive Electrode Active Material

As for the positive electrode active material, a carbon material, where a distance between (002) planes, d(002), of the carbon material as measured by X-ray diffraction is 0.340 nm or greater but 0.360 nm or less, and the carbon material has a BET specific surface area of greater than 1 m²/g but smaller than 30 m²/g, is used as a main component. When the d(002) is smaller than 0.340 nm, the carbon material typically exhibits characteristics of graphite, hence the carbon material has poor load characteristics, especially poor large-current charging properties, though the carbon material has a high capacity. When the d(002) is greater than 0.360 nm, the carbon material typically exhibits characteristics of non-graphitizing carbon or activated carbon, hence anions are adsorbed only on surfaces, and are hardly inserted between layers. Therefore, a high capacity element cannot be attained.

When the BET specific surface area is 1 m²/g or less, it is disadvantageous in terms of load properties, as a reaction area of the carbon material is small. When the BET specific surface area is 30 m²/g or greater, charging voltage cannot be set high, as the carbon material tends to decompose the electrolyte as high voltage is applied. Accordingly, anions are not sufficiently inserted between layers, and a high capacity of a resulting element cannot be achieved. The BET specific surface area can be typically determined by using a formula of BET in accordance with a gas adsorption method using nitrogen gas.

As for the carbon having the aforementioned characteristics, there is graphitizable carbon, which is carbon obtained by baking coke or mesophase pitch at a temperature about 2,000° C. or lower.

Whether the carbon material as specified in the present invention is used can be determined by measuring the BET specific surface area, if the carbon material is an active material in the state of a powder before formed into an electrode layer. After the carbon material is formed into an electrode layer, use of the carbon material can be determined by determining d(002) to be in the range of from 0.340 nm to 0.360 nm through an X-ray diffraction measurement of a positive electrode active material of a discharged state, and studying a charging-discharging curve by producing a battery with the positive electrode taken out, and lithium as a counter electrode. The details are described in Examples. In the case where the carbon for use in the present invention is used, the charging capacity attained with 4V or greater is larger than the charging capacity up to 4V, when the element is charged with the electric current value smaller than 0.1 A/g per unit mass of the positive electrode active material. This is because charging and discharging are performed by utilizing adsorption and elimination of anions between planes of the carbon materials.

In the case where the activated carbon, which is Comparative Example of Japanese Patent No. 5042754, is used, the capacity charged with 4V or lower is all the capacity, as the element is operated with the positive electrode potential of 4 V (vs.Li/Li⁺) or lower. In the case where the alkali-activated graphitizable carbon, which is Example, is used, the charging capacity obtained at 4 V or lower is a large, i.e. a half the entire charging capacity or greater. In Japanese Patent No. 5042754, the potential of the positive electrode is depicted with V (vs.Li/Li⁺), and the potential of the cell where Li is used as a counter electrode, can be determined as the approximately same level.

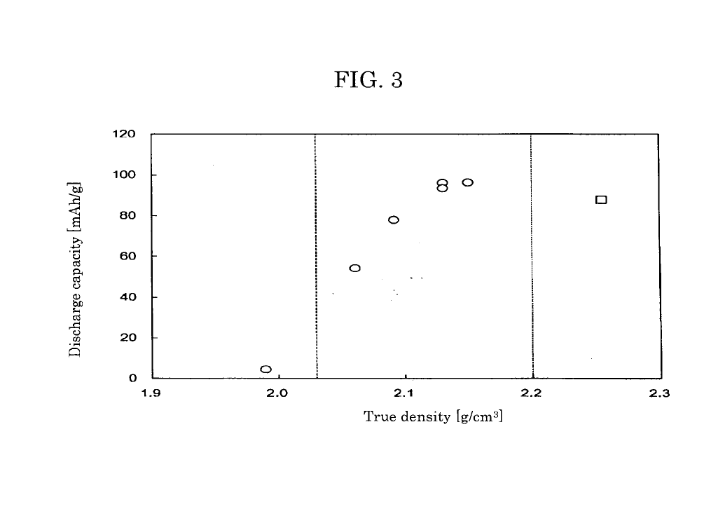

Moreover, the true density of the carbon material is preferably 2.03 g/cm³ or greater but less than 2.20 g/cm³. As a result of the research conducted by the present inventors, it has been found that there is a positive correlation between the true density of the carbon material and a capacity. When the true density of the carbon material is small, an element of high capacity cannot be attained. FIG. 3 illustrates a relationship between the discharge capacity at the 10th cycle, and the true density of carbon, when the carbon material is used as a positive electrode, Li metal is used as a negative electrode, a DMC solution containing 2.0 mol/L of LiPF₆ is used as an electrolyte, and the element is charged and discharged with the cut-off voltage of 3.0 V to 5.2 V. When the true density is 2.03 g/cm³ or greater, the practical value of the discharging capacity, i.e., 40 mAh/g or greater, can be attained. A large capacity is attained also when the true density is 2.20 g/cm³ or greater. However, the carbon material having the true density of 2.20 g/cm³ or greater exhibits characteristics of graphite, which include a high capacity, but poor load properties, particularly high-current charging properties. Accordingly, the true density of 2.20 g/cm³ or greater is not preferable.

### (2) Binder and Thickening Agent

The binder and thickening agent are appropriately selected depending on the intended purpose without any limitation, provided that the binder and the thickening agent are materials stable to a solvent used during a production of an electrode, or an electrolyte, or applied potential. Examples of the binder and the thickening agent include a fluorobinder (e.g., polyvinylidene fluoride (PVDF), and polytetrafluoroethylene (PTFE)), ethylene-propylene-butadiene rubber (EPBR), styrene-butadiene rubber (SBR), isoprene rubber, acrylate-based latex, carboxymethyl cellulose (CMC), methyl cellulose, hydroxymethyl cellulose, ethyl cellulose, polyacrylic acid, polyvinyl alcohol, alginic acid, oxidized starch, starch phosphate, and casein. These binders and thickening agents may be used alone or in combination. Among them, preferred are a fluorobinder (e.g., polyvinylidene fluoride (PVDF), and polytetrafluoroethylene (PTFE)), acrylate-based latex, and carboxymethyl cellulose (CMC).

### (3) Conduction Promoting Agent

Examples of the conduction promoting agent include a metal material (e.g., copper, and aluminium), and a carbonaceous material (e.g., carbon black, acetylene black, and carbon nanotube). These conduction promoting agents may be used alone or in combination.

### 1-2. Positive Electrode Collector

A material, shape, size, and structure of the positive electrode collector are appropriately selected depending on the intended purpose without any limitation.

A material of the positive electrode collector is appropriately selected depending on the intended purpose without any limitation, provided that the material is formed of a conductive material, and is stable to applied potential. Examples of the material include stainless steel, nickel, aluminium, titanium, and tantalum. Among them, stainless steel, and aluminium are particularly preferable.

A shape of the positive electrode collector is appropriately selected depending on the intended purpose without any limitation.

A size of the positive electrode collector is appropriately selected depending on the intended purpose without any limitation, provided that the size of the positive electrode collector is a size usable for a non-aqueous electrolyte storage element.

### 1-3. Production Method of Positive Electrode

The positive electrode can be produced by applying the positive electrode material on the positive electrode collector, and drying the applied the positive electrode material, where the positive electrode material is prepared by optionally adding the binder, the thickening agent, the conduction promoting agent, and a solvent to the positive electrode active material to form a slurry. The solvent is appropriately selected depending on the intended purpose without any limitation. Examples of the solvent include an aqueous solvent, and an organic solvent. Examples of the aqueous solvent include water, and alcohol. Examples of the organic solvent include N-methyl-2-pyrrolidone (NMP), and toluene.

Note that, the positive electrode active material may be subjected to roll molding as it is to form a sheet electrode, or to compression molding to form a pellet electrode.

### 2. Negative Electrode

The negative electrode is appropriately selected depending on the intended purpose without any limitation, provided that the negative electrode contains a negative electrode active material. Examples of the negative electrode include a negative electrode, in which a negative electrode material containing a negative electrode active material is disposed on a negative electrode collector.

A shape of the negative electrode is appropriately selected depending on the intended purpose without any limitation. Examples of the shape of the negative electrode include a plate shape.

### 2-1. Negative Electrode Material

The negative electrode material contains at least a negative electrode active material, and may further contain a conduction promoting agent, a binder, and a thickening agent, if necessary.

### (1) Negative Electrode Active Material

The negative electrode active material is not particularly limited, as long as the negative electrode active material is a material, which is capable of inserting and eliminating lithium ions at least in a non-aqueous solvent system. Specific examples of the negative electrode active material include: a carbonaceous material; metal oxide capable of inserting and eliminating lithium, such as lithium titanate, titanium oxide, antimony-doped tin oxide, and silicon monoxide; metal or alloy capable of forming an alloy with lithium, such as aluminum, tin, silicon, and zinc; and a composite alloy compound composed of metal capable of forming an alloy with lithium and an alloy containing the metal. These materials can be used alone or in combination. Among them, particularly preferred as materials, which are highly safe and suitable for high electric current input and output, are a carbonaceous material, and lithium titanate.

Examples of the carbonaceous material include activated carbon, graphite (artificial graphite, and natural graphite), graphitizable carbon, non-graphitizing carbon, and a thermal decomposition product of an organic material under various thermal decomposition conditions.

Examples of the lithium titanate include Li₄Ti₅O₁₂.

### (2) Binder and Thickening Agent

The binder and thickening agent are appropriately selected depending on the intended purpose without any limitation, provided that the binder and the thickening agent are materials stable to a solvent used during a production of an electrode, or an electrolyte, or applied potential. Examples of the binder and the thickening agent include a fluorobinder (e.g., polyvinylidene fluoride (PVDF), and polytetrafluoroethylene (PTFE)), ethylene-propylene-butadiene rubber (EPBR), styrene-butadiene rubber (SBR), isoprene rubber, acrylate-based latex, carboxymethyl cellulose (CMC), methyl cellulose, hydroxymethyl cellulose, ethyl cellulose, polyacrylic acid, polyvinyl alcohol, alginic acid, oxidized starch, starch phosphate, and casein. These binders and thickening agents may be used alone or in combination. Among them, preferred are a fluorobinder (e.g., polyvinylidene fluoride (PVDF), and polytetrafluoroethylene (PTFE)), styrene-butadiene rubber (SBR), and carboxymethyl cellulose (CMC).

### (3) Conduction Promoting Agent

Examples of the conduction promoting agent include a metal material (e.g., copper, and aluminium), and a carbonaceous material (e.g., carbon black, acetylene black, and carbon nanotube). These conduction promoting agents may be used alone or in combination.

### 2-2. Negative Electrode Collector

A material, shape, size, and structure of the negative electrode collector are appropriately selected depending on the intended purpose without any limitation.

A material of the negative electrode collector is appropriately selected depending on the intended purpose without any limitation, provided that the material is formed of a conductive material, and stable to applied potential. Examples of the material of the negative electrode collector include stainless steel, nickel, aluminium, and copper. Among them, particularly preferred are stainless steel, copper, and aluminium.

A shape of the collector is appropriately selected depending on the intended purpose without any limitation.

A size of the collector is appropriately selected depending on the intended purpose without any limitation, provided that the size of the positive electrode collector is a size usable for a non-aqueous electrolyte storage element.

### 2-3. Production Method of Negative Electrode

The negative electrode can be produced by applying the negative electrode material onto the negative electrode collector, and drying the applied negative electrode material, where the negative electrode material is prepared by optionally adding the binder, the thickening agent, the conduction promoting agent, and a solvent to the negative electrode active material to form a slurry. As for the solvent, the same solvent used in the production method of the positive electrode can be used.

Moreover, the composition prepared by adding the binder, the thickening agent, and the conduction promoting agent to the negative electrode active material may be subjected to roll molding as it is to form a sheet electrode, or to compression molding to form a pellet electrode. Furthermore, a thin film of the negative electrode active material may be formed on the negative electrode collector by a method, such as vapor deposition, sputtering, and plating.

### 3. Non-Aqueous Electrolyte

The non-aqueous electrolyte is an electrolyte prepared by dissolving an electrolyte salt in a non-aqueous solvent.

### 3-1. Non-Aqueous Solvent

The non-aqueous solvent is appropriately selected depending on the intended purpose without any limitation, but the non-aqueous solvent is suitably an aprotic organic solvent.

As for the aprotic organic solvent, a carbonate-based organic solvent, such as chain carbonate, and cyclic carbonate, is used. The aprotic organic solvent is preferably a solvent of low viscosity. Among them, chain carbonate is preferable, because of high solubility of an electrolyte salt.

Examples of the chain carbonate include dimethyl carbonate (DMC), diethyl carbonate (DEC), and methyl ethyl carbonate (EMC). Among them, dimethyl carbonate (DMC) is preferable, as use of the DMC can increase the discharging capacity per unit mass of the active material, and tends to improve charging-discharging efficiency, and cycle properties.

An amount of the DMC for use is appropriately selected depending on the intended purpose without any limitation. The amount of the DMC is preferably 70% by mass or greater relative to the non-aqueous solvent. As the amount of the DMC is 70% by mass or greater, an amount of a cyclic material having a high dielectric constant (e.g., cyclic carbonate, and cyclic ester) is not large when the rest of the solvent is composed of the cyclic material having a high dielectric constant. Accordingly, a viscosity of a non-aqueous electrode is not high, even when the non-aqueous electrolyte of a high concentration, i.e., 3.0 mol/L or greater, is produced, hence problems, such as penetration of the non-aqueous electrolyte into an electrode, or scattering of ion can be prevented.

The concentration of the electrolyte can be increased by setting the proportion of the chain carbonate to 100%, and hence reducing the viscosity of the electrolyte. As a result, a high charging-discharging capacity can be attained, but a charging-discharging efficiency is reduced.

In order to achieve a high charging-discharging efficiency, a coating film that protects an electrode is formed, and the active point of the electrode is prevented from directly contacting with a non-aqueous electrolyte to thereby prevent decomposition of an electrolyte. Cyclic carbonate is effective for forming a protective coating film. Among cyclic carbonate, fluorinated cyclic carbonate is particularly named as a substance that can be formed into a protective coating film, particularly at the side of the positive electrode. Other examples include cyclic sulfone, and cyclic sulfonic acid ester.

Examples of the cyclic carbonate include propylene carbonate (PC), ethylene carbonate (EC), butylene carbonate (BC), and vinylene carbonate (VC). Examples of the fluorinated cyclic carbonate include 4-fluoroethylenecarbonate (FEC), 4,4-difluoroethylenecarbonate, 4,5-difluorocarbonate, and trifluoropropylene carbonate. The fluorinated cyclic carbonate content in the non-aqueous solvent is preferably in the range from 0.1% by mass through 10.0% by mass. As the fluorinated cyclic carbonate content is 10.0% by mass or less, the viscosity of the solvent is maintained not too high. As the fluorinated cyclic carbonate content is 0.1% by mass or greater, moreover, a sufficient effect of charging-discharging efficiency can be attained.

Examples of the cyclic sulfone include sulfolane, and 3-methylsulfolane. Examples of the cyclic sulfonic acid ester include 1,3-propanesultone, and 1,4-butanesultone. The cyclic sulfone and cyclic sulfonic acid ester contents in the non-aqueous solvent is preferably in the range from 0.1% by mass through 5.0% by mass. As the cyclic sulfone and cyclic sulfonic acid ester contents are 5.0% by mass or less, the resistance of the positive electrode does not become excessively high. As the cyclic sulfone and cyclic sulfonic acid ester contents are 0.1% by mass or greater, moreover, a sufficient effect of improving charging-discharging efficiency can be attained.

In the case where dimethyl carbonate (DMC) is used as the chain carbonate, and ethylene carbonate (EC) is used as the cyclic carbonate, a blending ratio of dimethyl carbonate (DMC) and ethylene carbonate (EC), which is determined as a mass ratio (DMC:EC), is preferably from 85.0:15.0 through 99.0:1.0, more preferably from 90.0:10.0 through 99.0:1.0.

Optionally, an ester-based organic solvent (e.g., cyclic ester, and chain ester), or an ether-based organic solvent (e.g., cyclic ether, and chain ether) can be used as the non-aqueous solvent.

Examples of the cyclic ester include γ-butyrolactone (γBL), 2-methyl-γ-butyrolactone, acetyl-γ-butyrolactone, and γ-valerolactone.

Examples of the chain ester include alkyl propionate, dialkyl malonate, alkyl acetate (e.g., methyl acetate (MA), and ethyl acetate), and alkyl formate (e.g., methyl formate (MF), and ethyl formate).

Examples of the cyclic ether include tetrahydrofuran, alkyl tetrahydrofuran, alkoxy tetrahydrofuran, dialkoxy tetrahydrofuran, 1,3-dioxolan, alkyl-1,3-dioxolan, and 1,4-dioxolan.

Examples of the chain ether include 1,2-dimethoxyethane (DME), diethyl ether, ethylene glycol dialkyl ether, diethylene glycol dialkyl ether, triethylene glycol dialkyl ether, and tetraethylene glycol dialkyl ether.

### 3-2. Electrolyte Salt

As for the electrolyte salt, a lithium salt is used. The lithium salt is not particularly limited, as long as the lithium salt is dissolved in a non-aqueous solvent to exhibit high ion conductivity. Examples of the lithium salt include lithium hexafluorophosphate (LiPF₆), lithium perchlorate (LiClO₄), lithium chloride (LiCl), lithium fluoroborate (LiBF₄), lithium hexafluoroarsenate (LiAsF₆), lithium trifluorosulfonate (LiCF₃SO₃), lithium bistrifluoromethylsulfonyl imide (LiN(C₂F₅SO₂)₂), and lithium bisperfluoroethylsulfonyl imide (LiN(CF₂F₅SO₂)₂). These lithium salts may be used alone or in combination. Among them, LiPF₆ is preferable, because use of LiPF₆ increases an anion storage amount in the carbon electrode, and improves charging-discharging efficiency, and cycle properties.

The concentration of the electrolyte salt is 2.0 mol/L or greater. As the concentration thereof is 2.0 mol/L or greater, a discharge capacity per unit mass of the active material is high, and a battery having high charging-discharging efficiency can be attained. In view of high electric current discharging properties, and low temperature operation, the concentration thereof is preferably 4.0 mol/L or lower.

### 4. Separator

The separator is disposed between the positive electrode and the negative electrode for the purpose of preventing a short circuit between the positive electrode and the negative electrode.

A material, shape, size, and structure of the separator are appropriately selected depending on the intended purpose without any limitation.

Examples of a material of the separator include paper (e.g., Kraft paper, vinylon blended paper, and synthetic pulp blended paper), cellophane, a polyethylene graft membrane, polyolefin nonwoven fabric (e.g., polypropylene melt-flow nonwoven fabric), polyamide nonwoven fabric, glass fiber nonwoven fabric, and a micropore membrane.

Among them, a material having a porosity of 50% or greater is preferable in view of holding the electrolyte. As for a shape of the separator, a nonwoven fabric separator is more preferable than a thin film separator having micropores, as the porosity of the nonwoven fabric separator is higher. A thickness of the separator is preferably 20 μm or greater in view of prevention of short circuits, and retention of the electrolyte.

A size of the separator is appropriately selected depending on the intended purpose without any limitation, provided that the size of the separator is a size usable for a non-aqueous electrolyte storage element.

A structure of the separator may be a single-layer structure, or a multilayer structure.

### 5. Production Method of Non-Aqueous Electrolyte Storage Element

The non-aqueous electrolyte storage element of the present invention is produced by assembling positive electrode, the negative electrode, the non-aqueous electrolyte, and an optional separator into an appropriate shape. Moreover, other constitutional members, such as an outer tin, can be used, if necessary. The assembling method of the non-aqueous electrolyte storage element is appropriately selected from generally employed methods without any limitation.

The shape of the non-aqueous electrolyte storage element of the present invention is appropriately selected from various shapes typically adapted (e.g., a cylinder, a rectangular, a coin shape, and a laminate) depending on use thereof, without any limitation.

### 6. Use

Use of the non-aqueous electrolyte storage element of the present invention is not particularly limited, and the non-aqueous electrolyte storage element can be used for various use. Examples thereof include a laptop computer, a stylus-operated computer, a mobile computer, an electronic book player, a mobile phone, a mobile fax, a mobile printer, a headphone stereo, a video movie, a liquid crystal television, a handy cleaner, a portable CD, a minidisk, a transceiver, an electronic organizer, a calculator, a memory card, a mobile tape recorder, a radio, a back-up power supply, a motor, lighting equipment, a toy, game equipment, a clock, a strobe, and a camera.

### EXAMPLES

Examples of the present invention are described hereinafter, but the present invention is not limited to these examples in any way.

### Example 1

As for a positive electrode active material, Graphitizable Carbon A obtained by baking ground raw coke at 1,200° C. in an inert atmosphere was used. The average particle diameter D50 of the graphitizable carbon used in the present example as measured by laser diffraction, the plane distance d(002) thereof as measured by X-ray diffraction, the BET specific surface area thereof, and the value of the true density thereof as measured by a picnometer are presented in Table 2 below.

To Graphitizable Carbon A, acetylene black (Denka Black powder, manufactured by Denka Company Limited) serving as a conduction promoting agent, an acrylate-based latex (TRD202A, manufactured by JSR Corporation) serving as a binder, and carboxymethyl cellulose (DAICEL 2200, manufactured by Daicel Corporation) serving as a thickening agent were mixed in a manner that a mass ratio thereof based on the solid contents thereof were to be 100.0:7.5:3.8:3.0.

Subsequently, water was added to the resulting mixture to form a slurry of an appropriate viscosity. The slurry was then applied onto one side of an aluminium foil having a thickness of 20 μm by means of a doctor blade. The average coated amount after drying was 11 mg/cm². A circle having a diameter of 16 mm was stamped out of the resultant, to thereby produce a positive electrode.

As for a separator, stacked two sheets, each of which had been prepared by stamping a circle having a diameter of 16 mm out from glass filter paper (GA100, of ADVANTEC), were used. As for a negative electrode, a lithium metal foil having a diameter of 16 mm was used.

As for an electrolyte, an EMC solution containing 2.0 mol/L of LiPF₆ was used.

### <Production and Measurement of Battery>

After vacuum heat drying the positive electrode, and the separator, a CR2032 coin cell was assembled in a dry argon glove box.

The produced battery element was maintained in a thermostat chamber of 25° C., and was subjected to a charging-discharging test by means of a charging-discharging tester TOSCAT3100, manufactured by Toyo System Co., Ltd. under Conditions 1 to 8 depicted in Table 1 below. The reference current value was set to 2 mA, and the electric current values only for discharging under the condition 2 and the condition 6 were a value 5 times the reference current value, and a value 10 times the reference current value, respectively. The electric current values only for charging under the condition 4 and the condition 8 were a value 5 times the reference current value, and a value 10 times the reference current value, respectively. Moreover, under the all conditions, the charging was performed with constant current with cut-off voltage of 5.2 V, and discharging was performed with constant current with cut-off voltage of 3.0 V. There were 5-minute intervals between the charging and the discharging, and between the discharging and the charging.

TABLE 1

| Charging- | | | | | | |
|---|---|---|---|---|---|---|
| discharging test | | Charging | | Discharging | | |
| Test | | | Cut-off | | Cut-off | Repeating |
| step | Condition | Current | voltage | Current | voltage | time |
| Step 1 | Condition 1 | 2 mA | 5.2 V | 2 mA | 3.0 V | 10 |
| Step 2 | Condition 2 | 2 mA | | 10 mA | | 5 |
| Step 3 | Condition 3 | 2 mA | | 2 mA | | 2 |
| Step 4 | Condition 4 | 10 mA | | 2 mA | | 5 |
| Step 5 | Condition 5 | 2 mA | | 2 mA | | 2 |
| Step 6 | Condition 6 | 2 mA | | 20 mA | | 5 |
| Step 7 | Condition 7 | 2 mA | | 2 mA | | 2 |
| Step 8 | Condition 8 | 20 mA | | 2 mA | | 5 |

### Example 2

A battery was produced in the same manner as in Example 1, provided that the solvent of the electrolyte was changed to a mixed solvent of EMC and DMC prepared at a mass ratio (EMC:DMC) of 50:50. The produced battery was subjected to the charging-discharging test in the same manner as in Example 1.

### Example 3

A battery was produced in the same manner as in Example 1, provided that the solvent of the electrolyte was changed to DMC. The produced battery was subjected to the charging-discharging test in the same manner as in Example 1.

### Example 4

A battery was produced in the same manner as in Example 1, provided that the solvent of the electrolyte was changed to a mixed solvent of EC and DMC prepared at a mass ratio (EC:DMC) of 10:90. The produced battery was subjected to the charging-discharging test in the same manner as in Example 1.

### Example 5

A battery was produced in the same manner as in Example 1, provided that the solvent of the electrolyte was changed to a mixed solvent of sulfolane (SL) and DMC prepared at a mass ratio (SL:DMC) of 2:98. The produced battery was subjected to the charging-discharging test in the same manner as in Example 1.

### Example 6

A battery was produced in the same manner as in Example 1, provided that graphite was used as the active material of the negative electrode, the negative electrode was replaced with a negative electrode produced in the following manner, and the solvent of the electrode was changed to DMC. The produced battery was subjected to the charging-discharging test in the same manner as in Example 1.

A negative electrode was produced as follows. Artificial graphite (MAGD, manufactured by Hitachi Chemical Company, Ltd.) serving as an active material, acetylene black (Denka Black powder, manufactured by Denka Company Limited) serving a conduction promoting agent, styrene-butadiene rubber (TRD 102A, manufactured by JSR Corporation) serving as a binder, and carboxymethyl cellulose (DAICEL 2200, manufactured by Daicel Corporation) serving as a thickening agent were mixed in the manner that the mass ratio thereof based on the solid contents thereof were to be 100:5:2:1. Subsequently, water was added to the resulting mixture to form a slurry of an appropriate viscosity. The slurry was then applied onto one side of an aluminium foil having a thickness of 18 μm by means of a doctor blade. The average coated amount after drying was 11.0 mg/cm².

### Example 71

A battery was produced in the same manner as in Example 1, provided that lithium titanate was used as the active material of the negative electrode, the negative electrode was replaced with a negative electrode produced in the following manner, and the solvent of the electrode was changed to DMC. The produced battery was subjected to the charging-discharging test in the same manner as in Example 1.

A negative electrode was produced as follows. Lithium titanate (manufactured by Ishihara Sangyo Kaisha, Ltd.) serving as an active material, acetylene black (Denka Black powder, manufactured by Denka Company Limited) serving a conduction promoting agent, styrene-butadiene rubber (TRD 102A, manufactured by JSR Corporation) serving as a binder, and carboxymethyl cellulose (DAICEL 2200, manufactured by Daicel Corporation) serving as a thickening agent were mixed in the manner that the mass ratio thereof based on the solid contents thereof were to be 100:7:3:1. Subsequently, water was added to the resulting mixture to form a slurry of an appropriate viscosity. The slurry was then applied onto one side of an aluminium foil having a thickness of 18 μm by means of a doctor blade. The average coated amount after drying was 7.0 mg/cm².

Since the action potential of the lithium titanate was 1.5 V (vsLi/Li+), the charging-discharging test was performed with the cut-off voltage of 3.7 V for the charging, and the cut-off voltage of 1.5 V for the discharging.

### Example 8

A battery was produced in the same manner as in Example 1, provided that the negative electrode was replaced with a lithium titanate negative electrode that was identical to the one used in Example 7, and the electrolyte was replaced with a FEC/EMC/DMC mixed solvent (a mass ratio FEC:EMC:DMC=25:25:50) containing 2.0 mol/L of LiBF₄. The produced battery was subjected to the charging-discharging test in the same manner as in Example 1.

### Example 9

A battery was produced in the same manner as in Example 1, provided that the negative electrode was replaced with a graphite negative electrode that was identical to the one used in Example 6, and the electrolyte was replaced with a DMC solution containing 3.0 mol/L of LiPF₆. The produced battery was subjected to the charging-discharging test in the same manner as in Example 1.

### Example 10

A battery was produced in the same manner as in Example 1, provided that the negative electrode was replaced with a graphite negative electrode that was identical to the one used in Example 6, and the solvent of the electrolyte was replaced with an EC/FEC/DMC mixed solvent (a mass ratio EC:FEC:DMC=2:2:96). The produced battery was subjected to the charging-discharging test in the same manner as in Example 1.

### Example 11

A battery was produced in the same manner as in Example 1, provided that the lithium salt of the electrolyte was replaced with a mixed salt of 1.0 mol/L of LiBF₄ and 1.0 mol/L of LiPF₆, and the solvent of the electrolyte was replaced with an EC/FEC/DMC mixed solvent (a mass ratio EC:FEC:DMC=2:2:96). The produced battery was subjected to the charging-discharging test in the same manner as in Example 1.

### Example 12

A battery was produced in the same manner as in Example 1, provided that the lithium salt of the electrolyte was replaced with 2.0 mol/L of LiBF₄, and the solvent of the electrolyte was replaced with an EC/FEC/DMC mixed solvent (a mass ratio EC:FEC:DMC=2:2:96). The produced battery was subjected to the charging-discharging test in the same manner as in Example 1.

### Example 13

A battery was produced in the same manner as in Example 1, provided that the positive electrode active material was replaced with Graphitizable Carbon B obtained by baking raw coke, which had been ground finer than the raw coke used in Example 1, at 1,200° C. in an inert atmosphere, and the solvent of the electrolyte was replaced with an EC/FEC/DMC mixed solvent (a mass ratio EC:FEC:DMC=2:2:96). The produced battery was subjected to the charging-discharging test in the same manner as in Example 1.

The average particle diameter D50 of Graphitizable Carbon B, the plane distance d(002) thereof, the BET specific surface area thereof, and the value of the true density thereof are presented in Table 2 below.

### Example 14

A battery was produced in the same manner as in Example 1, provided that the positive electrode active material was replaced with Graphitizable Carbon C obtained by baking raw coke, which was different from the raw coke used in Example 1, at 1,500° C. in an inert atmosphere, and the solvent of the electrolyte was replaced with an EC/FEC/DMC mixed solvent (a mass ratio EC:FEC:DMC=2:2:96). The produced battery was subjected to the charging-discharging test in the same manner as in Example 1.

The average particle diameter D50 of Graphitizable Carbon C, the plane distance d(002) thereof, the BET specific surface area thereof, and the value of the true density thereof are presented in Table 2 below.

### Comparative Examples 1 to 3

As a positive electrode active material, artificial graphite (KS6, manufactured by TIMCAL) was used in Comparative Example 1, artificial graphite (MAGD, manufactured by Hitachi Chemical Company, Ltd.) was used in Comparative Example 2, and non-graphitizable carbon (LBV-1001, manufactured by Sumitomo Bakelite Co., Ltd.) was used in Comparative Example 3. The average particle diameters D50 of these carbon materials as measured by laser diffraction, the plane distances d(002) thereof as measured by X-ray diffraction, the BET specific surface areas thereof, and the values of the true density thereof as measured by a picnometer are presented in Table 2 below.

Other than the positive electrode active material as described above, electrodes, and a battery of each comparative example were produced and evaluated in the same manner as in Example 3.

When the charging-discharging properties were evaluated, the reference current was 0.6 mA only in Comparative Example 2, and was 2 mA in other comparative examples.

### Comparative Example 4

An electrode was produced using acetylene black (Denka Black powder, manufactured by Denka Company Limited) as a positive electrode active material. The average particle diameter D50 of the acetylene black as measured by laser diffraction, the plane distance d(002) thereof as measured by X-ray diffraction, the BET specific surface area thereof, and the value of the true density thereof as measured by a picnometer are presented in Table 2 below.

The acetylene black could not be formed into an excellent slurry with the same method to the method used in Example 1. Therefore, artificial graphite (MAGD, manufactured by Hitachi Chemical Company, Ltd.) was added to the acetylene black, and CMC was used as a binder as well as a thickening agent. A mass ratio (acetylene black:artificial graphite:CMC) of the acetylene black, artificial graphite, and CMC based on the solid contents was 50:20:5. Moreover, the coated amount was 2.9 mg/cm². As the coated amount was small, as for the charging-discharging conditions, the evaluation was performed with the reference current value of 0.5 mA.

### Comparative Example 5

A battery was produced in the same manner as in Example 1, provided that the positive electrode active material was replaced with Graphitizable Carbon D obtained by baking raw coke identical to the raw coke used in Example 1 at 1,800° C. in an inert atmosphere, and the solvent of the electrolyte was replaced with an EC/FEC/DMC mixed solvent (a mass ratio EC:FEC:DMC=2:2:96). The produced battery was subjected to the charging-discharging test in the same manner as in Example 1.

The average particle diameter D50 of Graphitizable Carbon D, the plane distance d(002) thereof, the BET specific surface area thereof, and the value of the true density thereof are presented in Table 2 below.

### Comparative Example 6

As for a positive electrode active material, Graphitizable carbon E prepared by baking raw coke identical to the one used in Example 14 at 1,500° C. in an inert atmosphere, and sieving with a mesh of 3 μm was used. As Graphitizable Carbon E had a large specific surface area, a preferable slurry was not formed with the same amounts of the conductive promoting agent, binder, and thickening agent to those in Example 14. Accordingly, an electrode was produced with a mass ratio of (active material:conduction promoting agent:binder:thickening agent) of 100.0:15.0:5.0:8.0 based on the solid contents thereof. Using the electrode, a battery was produced in the same manner as in Example 1, provided that the solvent was replaced with a mixed solvent having a mass ratio (EC:FEC:DMC) of 2:2:96. The produced battery was subjected to the charging-discharging test in the same manner as in Example 1.

The average particle diameter D50 of Graphitizable Carbon E, the plane distance d(002) thereof, the BET specific surface area thereof, and the value of the true density thereof are presented in Table 2 below.

The materials and physical properties of the positive electrode active materials used in Examples and Comparative Examples are depicted in Table 2.

The types of the positive electrode active material and negative electrode, and the composition of the electrolyte of the batteries of Examples and Comparative Examples are depicted in Table 3.

TABLE 2

| | | | Specific | |
|---|---|---|---|---|
| Positive electrode active | D50 | d(002) | surface area | True density |
| material | (μm) | (nm) | (m²/g) | (g/cm³) |
| Graphitizable Carbon A | 15.3 | 0.345 | 2.4 | 2.15 |
| Graphitizable Carbon B | 3.5 | 0.345 | 21.0 | 2.14 |
| Graphitizable Carbon C | 7.2 | 0.346 | 12.1 | 2.16 |
| Graphitizable Carbon D | 10.2 | 0.338 | 2.5 | 2.19 |
| Graphitizable Carbon E | 1.5 | 0.346 | 31.1 | 2.15 |
| Artificial graphite (KS6) | 3.4 | 0.336 | 20.0 | 2.36 |
| Artificial graphite | 21.1 | 0.336 | 4.3 | 2.23 |
| (MAGD) | | | | |
| Non-graphitizing carbon | 10.0 | 0.372 | 2.9 | NA |
| (LBV-1001) | | | | |
| Acetylene black | 0.035 | 0.351 | 68.0 | NA |

NA: not measured

TABLE 3

| | Positive electrode active | Negative | | |
|---|---|---|---|---|
| | material | electrode | Lithium salt | Solvent |
| Ex. 1 | Graphitizable Carbon A | Li | 2.0 mol/L LiPF₆ | EMC |
| Ex. 2 | Graphitizable Carbon A | Li | 2.0 mol/L LiPF₆ | EMC:DMC |
| | | | | (50:50) |
| Ex. 3 | Graphitizable Carbon A | Li | 2.0 mol/L LiPF₆ | DMC |
| Ex. 4 | Graphitizable Carbon A | Li | 2.0 mol/L LiPF₆ | EC:DMC (10:90) |
| Ex. 5 | Graphitizable Carbon A | Li | 2.0 mol/L LiPF₆ | SL:DMC (2:98) |
| Ex. 6 | Graphitizable Carbon A | Artificial | 2.0 mol/L LiPF₆ | DMC |
| | | graphite (MAGD) | | |
| Ex. 7 | Graphitizable Carbon A | Lithium titanate | 2.0 mol/L LiPF₆ | DMC |
| Ex. 8 | Graphitizable Carbon A | Lithium titanate | 2.0 mol/L LiBF₄ | FEC:EMC:DMC |
| | | | | (25:25:50) |
| Ex. 9 | Graphitizable Carbon A | Artificial | 3.0 mol/L LiPF₆ | DMC |
| | | graphite (MAGD) | | |
| Ex. 10 | Graphitizable Carbon A | Artificial | 2.0 mol/L LiPF₆ | EC:FEC:DMC |
| | | graphite (MAGD) | | (2:2:96) |
| Ex. 11 | Graphitizable Carbon A | Li | 1.0 mol/L LiPF₆ | EC:FEC:DMC |
| | Graphitizable Carbon A | | 1.0 mol/L LiBF₄ | (2:2:96) |
| Ex. 12 | Graphitizable Carbon A | Li | 2.0 mol/L LiBF₄ | EC:FEC:DMC |
| | | | | (2:2:96) |
| Ex. 13 | Graphitizable Carbon B | Li | 2.0 mol/L LiPF₆ | EC:FEC:DMC |
| | | | | (2:2:96) |
| Ex. 14 | Graphitizable Carbon C | Li | 2.0 mol/L LiPF₆ | EC:FEC:DMC |
| | | | | (2:2:96) |
| Comp. | Artificial graphite (KS6) | Li | 2.0 mol/L LiPF₆ | DMC |
| Ex. 1 | | | | |
| Comp. | Artificial graphite | Li | 2.0 mol/L LiPF₆ | DMC |
| Ex. 2 | (MAGD) | | | |
| Comp. | Non-graphitizing carbon | Li | 2.0 mol/L LiPF₆ | DMC |
| Ex. 3 | (LBV-1001) | | | |
| Comp. | Acetylene black (50) | Li | 2.0 mol/L LiPF₆ | DMC |
| Ex. 4 | Artificial graphite | | | |
| | (MAGD)(20) | | | |
| Comp. | Graphitizable Carbon D | Li | 2.0 mol/L LiPF₆ | EC:FEC:DMC |
| Ex. 5 | | | | (2:2:96) |
| Comp. | Graphitizable Carbon E | Li | 2.0 mol/L LiPF₆ | EC:FEC:DMC |
| Ex. 6 | | | | (2:2:96) |

### (Charging-Discharging Test)

The batteries produced in Examples and Comparative Examples were subjected to a charging-discharging test depicted in Table 1. The results of the charging-discharging test are presented in Table 4. The values of the charge capacity (mAh/g) of the reference current of the 10th cycle up to 4 V are also presented. In the case where graphite or lithium titanate was used for the negative electrode instead of Li, the potential of the graphite was set to 0.3 V (vs.Li/Li⁺), or the potential of the lithium titanate was set to 1.5 V (vs.Li/Li+) to make the potential of the positive electrode 4 V (vs.Li/Li⁺), and charging capacities up to the cell voltage of 3.7 V and 2.5 V, respectively, were depicted. In Examples, the charging capacity up to 4 V relative to the entire capacity was small, i.e., the range from 2% through 12%, from which it was found that the charging capacity was realized through a mechanism different from the mechanism disclosed in Japanese Patent No. 5042754.

The results of the charging-discharging test are analyzed hereinafter.

### (X-Ray Diffraction in Charging-Discharging Process)

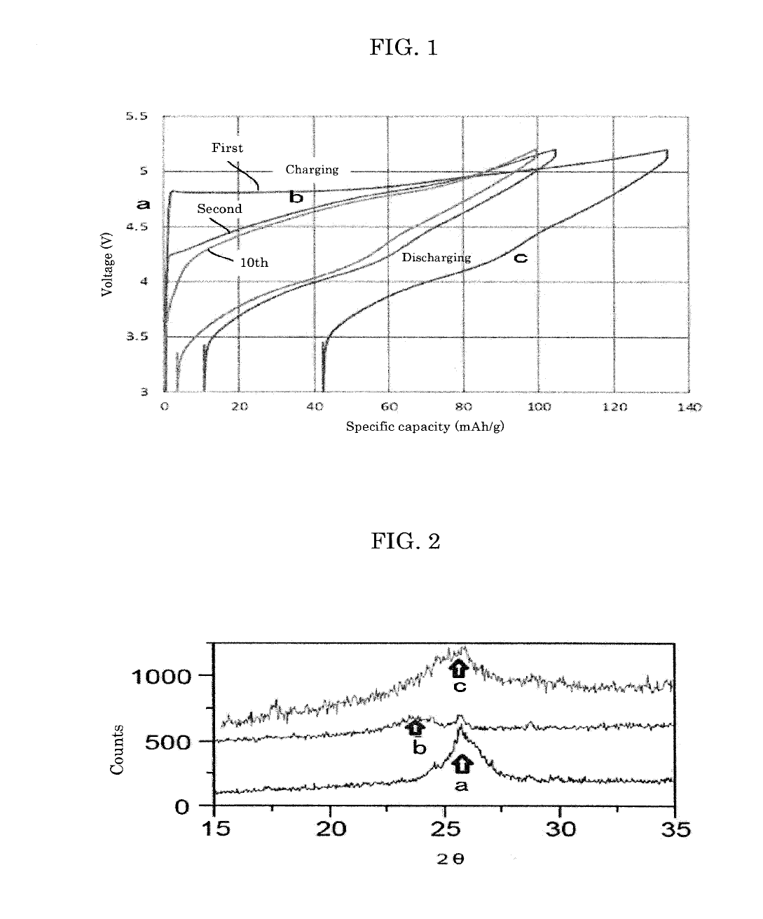

Charging-discharging curves of the first, second, and 10th charging-discharging cycles of Example 3 with the reference current are depicted in FIG. 1. In the first cycle, the voltage was hardly increased up to the capacity of 60 mAh/g after rapidly increased to 4.8 V, and the voltage was gradually increased with the capacity of 60 mAh/g or greater. The charging performed at the second cycle or later, there was no region where the voltage was hardly increased, and the increase of the voltage became mild from around 4.2 V. A shape of the curve gradually changed per cycle, and the charging-discharging efficiency increased. However, the change of the curve and the charging-discharging efficiency were almost stabilized at the 10th cycle, and a change in the charging-discharging curve was small after the 10th cycle. The capacity mentioned here is a capacity per unit mass of the positive electrode active material.

A cell having a Be window through which X-ray diffraction of the electrode could be measured was used, and the measurement of a peak whose center was 2θ=26° was performed using CuKα rays. The results are presented in FIG. 2. In the region represented by a in FIG. 1, which was from before the charging through 4.8 V, a peak appeared at the position whose center was 2θ=26°. In the region represented by b exceeding 4.8 V, a broad peak whose center was 2θ=23° was appeared. At the time of discharging, the peak was returned to the position before the charging at 3.5 V or less. The peak adjacent to 20=26° corresponds to the plane distance d(002) of the graphite structure. The shift of the peak to the lower angle side can be interpreted as the plane distance is increased.

The plane distance d(002) before charging was calculated as 0.345 nm based on the peak position.

X-ray diffraction during the second charging-discharging process was also measured. There was a difference in the voltage, i.e., 4.3 V or greater, at which the peak position of a was sifted to the position of b in FIG. 2, but the peak position was the same after the change. At the time of the discharging, the peak position was returned to the position before the charging at the voltage of 3.5 V or less. Based on the aforementioned findings, it was assumed that the d(002) became large during the charging, as PF₆⁻ was inserted between planes of the graphitizable carbon, and the d(002) was returned to the value before the charging at the time of the discharging, as PF₆⁻ was eliminated from between the planes. It was then confirmed that the graphitizable carbon could realize a large capacity through insertion and elimination of anion into and from between layers, similarly to the case of graphite.

In case of activated carbon or alkali-activated graphitizable carbon, insertion of anions into between layers is not utilized. As depicted in FIGS. 6 and 7 of Japanese Patent No. 5042754, therefore, such the carbon material gives a capacity from a relatively low potential, but anions are not inserted between layers even when the potential is increased. Accordingly, the final capacity is small.

In all of Examples 1 to 3, the discharging capacity at the 10th cycle was large, and the capacity retentions at the discharging test and charging test with the electric current value 5 times or 10 times the reference current were also excellent values, i.e., approximately 80% or greater. The capacity retention is a ratio of the charging capacity obtained under each condition to the discharging capacity attained with the reference current at the 10th cycle. As the value of the capacity retention is closer to 100%, it indicates that excellent properties are attained relative to discharging and charging of high electric current.

The results of the charging-discharging efficiency at the 10th cycle were better in the order of Examples 1, 2, and 3. Specifically, the more preferable results were attained, when DMC was mixed with EMC as the electrolyte solvent, or DMC was independently used as the electrolyte solvent, than when only EMC was used as the electrolyte solvent. The charging-discharging efficiency is a ratio of the discharging capacity to the charging capacity. When a value of the charging-discharging efficiency is small, it is assumed that part of the charging capacity, which did not contribute to the discharging, was used for some sort of side reactions, such as decomposition of the electrolyte, and thus cycle deteriorations tends to be caused.

In Example 4, EC, which was one of cyclic carbonates was added to the electrolyte in addition to DMC. In Example 5, sulfolane (SL) was added to the electrolyte. In both cases, the charging-discharging efficiency was improved compared to the case where only DMC was used as the solvent of the electrolyte.

In Example 6, graphite was used for the negative electrode. In Examples 7 and 8, lithium titanate was used for the negative electrode. In the both cases, excellent properties were exhibited. Particularly in Examples 7 and 8 where lithium titanate was used for the negative electrode, the charging-discharging efficiency was high.

In Examples 9 and 10, graphite was used for the negative electrode. In Example 9, the salt concentration of the electrolyte was increased. In Example 10, EC and FEC were also added as the solvents into the electrolyte. In both Examples 9 and 10, excellent properties were exhibited, and the charging-discharging efficiency thereof was also high.

In Example 11, a half of the lithium salt for use was replaced with LiBF₄. In Example 12, the entire lithium salt for use was replaced with LiBF₄. When LiBF₄ was used, the charging-discharging efficiency tended to be slightly poor compared to the case where LiPF₆ was used independently. However, excellent properties were exhibited on the whole.

In Examples 13 and 14, the discharging capacity at the 10th cycle was large, and the capacity retentions in the discharging test and charging test at high electric current, such as 5 times and 10 times the reference current value, were excellent values, i.e., 80% or greater.

Comparative Examples 1 to 4 used the same electrolyte to the electrolyte used in Example 3, with changing the active material of the positive electrode for use.

In both Comparative Examples 1 and 2, graphite was used. Accordingly, the charging-discharging efficiency was higher than the charging-discharging efficiency of the example where graphitizable carbon was used. However, the capacity retentions thereof in the discharging test and charging test at high electric current, such as 5 times and 10 times the reference current value, were reduced. Particularly, a significant reduction in the capacity retention was observed in the charging test. Moreover, the discharging capacity at the 10th cycle with the reference current was small in Comparative Example 2.

Comparative Example 3 was an embodiment where so-called non-graphitizing carbon, d(002) of which was larger than those of Examples, was used, charging and discharging were hardly achieved.

In Comparative Example 4, the carbon material for use was the mixture of acetylene black and MAGD, and the physical properties of the carbon material depicted in Table 1 was the values of the acetylene black, and the mass of the carbon material used for the calculation of the discharge capacity of Table 4 was the value combining the acetylene black and MAGD. The d(002) of the mixture was close to that of Example 1, and was chargeable. In Comparative Example 4, the capacity retentions thereof in the discharging test and charging test at high electric current, such as 5 times and 10 times the reference current value, were also high. However, the discharging capacity at the 10th cycle with the reference current, and the charging-discharging capacity were significantly low. Since the specific surface area of the carbon material for use was large, it was assumed that decomposition of the electrolyte was caused significantly.

In Comparative Example 5, the discharging capacity at the 10th cycle, and the capacity retention in the discharging test with the electric current values 5 times and 10 times the reference current were large, but the capacity retention in the charging test with the electric current values 5 times and 10 times the reference current was small.

In Comparative Example 6, the discharging capacity at the 10th cycle was small, and the charging-discharging efficiency was also poor. Since the specific surface area of the carbon material for use was large, there was a possibility that decomposition of the electrolyte was caused significantly.

### (Voltammetry)

As depicted in Table 5, voltammetry was performed at 25° C. when SUS was used as a working electrode and lithium was used as a counter electrode, and DMC was used as a solvent of an electrolyte, and the concentration of LiPF₆ was changed between 1.0 mol/L, 4.0 mol/L, and 5.0 mol/L, and voltammetry was performed at 25° C. when platinum was used as a working electrode and lithium was used as a counter electrode, and a solvent of an electrolyte was a mixed solvent of EC, FEC, and DMC at a mass ratio (EC:FEC:DMC) of 2:2:96, and the concentration of LiPF₆ was changed between 2.0 mol/L, and 3 mol/L. The onset potential of oxidation was determined from the transient build-up current. The results are presented in Table 5.

It was found from the results that the concentration of the lithium salt in the electrolyte was preferably 2.0 mol/L or greater, and oxidative decomposition was suppressed, and charging-discharging efficiency was improved when the concentration of the lithium salt was set higher, such as 3.0 mol/L.

TABLE 4

| | | | | | At the | | At the |
|---|---|---|---|---|---|---|---|
| | | | | At the end | end of | At the end | end of |
| | | | | of Step 2 | Step 4 | of Step 6 | Step 8 |
| | At the end of Step 1 | | | Capacity | Capacity | Capacity | Capacity |
| | | | Charging- | retention | retention | retention | retention |
| | Charging | Discharging | discharging | for | for | for | for |
| | capacity* | capacity | efficiency | discharging | charging | discharging | charging |
| | (mAh/g) | (mAh/g) | (%) | (%) | (%) | (%) | (%) |
| Ex. 1 | 2.1 | 99 | 93.7 | 99 | 94 | 97 | 82 |
| Ex. 2 | 2.1 | 95 | 94.2 | 99 | 94 | 97 | 81 |
| Ex. 3 | 3.4 | 96 | 95 | 99 | 93 | 96 | 79 |
| Ex. 4 | 3.3 | 89 | 95.9 | 98 | 93 | 92 | 79 |
| Ex. 5 | 3.6 | 96 | 95.9 | 100 | 95 | 96 | 81 |
| Ex. 6 | 3.2 | 97 | 94.6 | 98 | 93 | 93 | 81 |
| Ex. 7 | 3.6 | 82 | 97.2 | 96 | 96 | 89 | 88 |
| Ex. 8 | 4.1 | 87 | 98.1 | 89 | 87 | 84 | 80 |
| Ex. 9 | 5.1 | 85 | 96.1 | 97 | 90 | 91 | 78 |
| Ex. 10 | 10.9 | 92 | 95.6 | 98 | 94 | 95 | 81 |
| Ex. 11 | 8.9 | 87 | 92.8 | 92 | 86 | 87 | 75 |
| Ex. 12 | 11.2 | 79 | 86.4 | 85 | 70 | 78 | 68 |
| Ex. 13 | 3.9 | 97 | 91.2 | 97 | 84 | 89 | 81 |
| Ex. 14 | 4.6 | 94 | 93.5 | 92 | 90 | 87 | 87 |
| Comp. | 1.5 | 87 | 97.4 | 91 | 44 | 71 | 4 |
| Ex. 1 | | | | | | | |
| Comp. | 0 | 51 | 96.9 | 88 | 47 | 68 | 16 |
| Ex. 2 | | | | | | | |
| Comp. | NA | NA | NA | NA | NA | NA | NA |
| Ex. 3 | | | | | | | |
| Comp. | 4.2 | 22 | 72 | 100 | 93 | 93 | 91 |
| Ex. 4 | | | | | | | |
| Comp. | 2.1 | 88 | 96.3 | 89 | 53 | 77 | 32 |
| Ex. 5 | | | | | | | |
| Comp. | 3.9 | 45 | 86 | 98 | 87 | 88 | 79 |
| Ex. 6 | | | | | | | |

*the charging capacity up to the positive electrode potential of 4 V (vs. Li/Li+) at the 10th cycle

TABLE 5

| | | | | Oxidation |
|---|---|---|---|---|
| | | Electrolyte composition | | onset |
| | Counter | | Non-aqueous | potential |
| | electrode | Electrolyte salt | solvent | (VvsLi/Li+) |
| SUS | Li | 1.0 mol/L LiPF₆ | DMC | 4.5 |
| Pt | Li | 2.0 mol/L LiPF₆ | EC:FEC:DMC | 5.5 |
| | | | (2:2:96) | |
| Pt | Li | 3.0 mol/L LiPF₆ | EC:FEC:DMC | 5.8 |
| | | | (2:2:96) | |
| SUS | Li | 4.0 mol/L LiPF₆ | DMC | 6.5 |
| SUS | Li | 5.0 mol/L LiPF₆ | DMC | 6.7 |

For example, the embodiments of the present invention are as follows.

<1> A non-aqueous electrolyte storage element including:
a positive electrode containing a positive electrode active material capable of inserting and eliminating anions;
a negative electrode containing a negative electrode active material capable of inserting and eliminating cations; and
a non-aqueous electrolyte prepared by dissolving an electrolyte salt in a non-aqueous solvent,
wherein the positive electrode active material contains a carbon material,
where a distance between (002) planes, d(002), of the carbon material as measured by X-ray diffraction is 0.340 nm or greater but 0.360 nm or less, and the carbon material has a BET specific surface area of greater than 1 m²/g but smaller than 30 m²/g, and
the negative electrode active material contains a material capable of inserting and eliminating lithium ions.
<2> The non-aqueous electrolyte storage element according to <1>, wherein the positive electrode active material is a carbon material having a true density of 2.03 g/cm³ or greater but smaller than 2.20 g/cm³.
<3> The non-aqueous electrolyte storage element according to <1> or <2>, wherein the negative electrode contains carbon, or lithium titanate.
<4> The non-aqueous electrolyte storage element according to any one of <1> to <3>, wherein the non-aqueous electrolyte contains lithium salt, and a concentration of the lithium salt in the non-aqueous electrolyte is 2.0 mol/L or greater but 4.0 mol/L or less.
<5> The non-aqueous electrolyte storage element according to any one of <1> to <4>, wherein the electrolyte contains dimethyl carbonate as the non-aqueous solvent.
<6> The non-aqueous electrolyte storage element according to any one of <1> to <5>, wherein the electrolyte contains at least one of cyclic carbonate and cyclic sulfone as the non-aqueous solvent.
<7> The non-aqueous electrolyte storage element according to <6>, wherein the cyclic carbonate contains fluorinated cyclic carbonate.

What is claimed is:

1. A non-aqueous electrolyte storage element comprising:
a positive electrode containing a positive electrode active material capable of inserting and eliminating anions;
a negative electrode containing a negative electrode active material capable of inserting and eliminating cations; and
a non-aqueous electrolyte prepared by dissolving an electrolyte salt in a non-aqueous solvent,
wherein the positive electrode active material contains a carbon material,
where a distance between (002) planes, d(002), of the carbon material as measured by X-ray diffraction is 0.340 nm or greater but 0.360 nm or less, and the carbon material has a BET specific surface area of greater than 1 m²/g but smaller than 30 m²/g, and
the negative electrode active material contains a material capable of inserting and eliminating lithium ions.

2. The non-aqueous electrolyte storage element according to claim 1, wherein the positive electrode active material is a carbon material having a true density of 2.03 g/cm³ or greater but smaller than 2.20 g/cm³.

3. The non-aqueous electrolyte storage element according to claim 1, wherein the negative electrode contains carbon, or lithium titanate.

4. The non-aqueous electrolyte storage element according to claim 1, wherein the non-aqueous electrolyte contains lithium salt, and a concentration of the lithium salt in the non-aqueous electrolyte is 2.0 mol/L or greater but 4.0 mol/L or less.

5. The non-aqueous electrolyte storage element according to claim 1, wherein the electrolyte contains dimethyl carbonate as the non-aqueous solvent.

6. The non-aqueous electrolyte storage element according to claim 1, wherein the electrolyte contains at least one of cyclic carbonate and cyclic sulfone as the non-aqueous solvent.

7. The non-aqueous electrolyte storage element according to claim 6, wherein the cyclic carbonate contains fluorinated cyclic carbonate.
